(19) United States
(12) Patent Application Publication
(10) Pub. No.: US 2025/0202368 A1
(43) Pub. Date: Jun. 19, 2025

(54) ISOLATED SWITCHING CONVERTER WITH ENERGY RECYCLING AND CONTROL METHOD THEREOF

(71) Applicant: Chengdu Monolithic Power Systems Co., Ltd., Chengdu (CN)

(72) Inventor: Xuefeng Chen, Hangzhou (CN)

(21) Appl. No.: 18/985,607

(22) Filed: Dec. 18, 2024

(30) Foreign Application Priority Data
Dec. 19, 2023 (CN) 202311765135.2

(51) Int. Cl. H02M 3/335; H02M 1/00; H02M 1/34

(52) U.S. Cl. CPC H02M 3/33569; H02M 1/0009; H02M 1/348

(57) ABSTRACT

A control circuit for an isolated switching converter having a transformer with a primary winding and a secondary winding, a primary switch, a secondary switch and an energy recycle branch. The energy recycle branch has a clamp capacitor, an auxiliary switch and a first resistor connected in series between a first terminal and a second terminal of the primary winding. The auxiliary switch has a first electrode coupled to the clamp capacitor and a second electrode coupled to the first resistor. The control circuit decreases a voltage difference between a control electrode and the second electrode of the auxiliary switch during a discharging process of the clamp capacitor based on a current sense signal representative of a current flowing through the energy recycle branch.

### CROSS-REFERENCE TO RELATED APPLICATIONS

This application claims the benefit of CN application No. 202311765135.2, filed on Dec. 19, 2023, and incorporated herein by reference.

### TECHNICAL FIELD OF THE INVENTION

The present invention generally relates to electronic circuits, and more particularly but not exclusively, to control circuits for isolated switching converters and associated methods.

### BACKGROUND

FIG. 1 shows a conventional RCD snubber 10 for an isolated switching converter 100. The RCD snubber 10 comprises a clamp capacitor Csn, a snubber resistor Rsn and a diode Dsn. When a primary control signal GP turns OFF a primary switch QP coupled to a primary winding Np, a leakage inductance Lk of a transformer T transfer its leakage inductance energy to charge the clamp capacitor Csn via the diode Dsn. After a charging process of the clamp capacitor Csn is over, the energy stored in the clamp capacitor Csn is consumed by the snubber resistor Rsn.

Although voltage spikes of the isolated switching converter 100 may be well suppressed, the efficiency of the isolated switching converter 100 is limited and not high since the leakage inductance energy is just burned out instead of being recycled.

### SUMMARY

An embodiment of the present invention discloses a control circuit for an isolated switching converter. The isolated switching converter having a transformer, a primary switch, a secondary switch and an energy recycle branch. The transformer has a primary winding and a secondary winding. The energy recycle branch has a clamp capacitor, an auxiliary switch and a first resistor connected in series between a first terminal and a second terminal of the primary winding. The control circuit comprises a first terminal, a second terminal and a third terminal. The first terminal of the control circuit is connected to the second terminal of the primary winding and the primary switch. The second terminal of the control circuit is connected to the first resistor to receive a current sense signal representative of a current flowing through the energy recycle branch. The third terminal of the control circuit is connected to a control electrode of the auxiliary switch to control the auxiliary switch. The auxiliary switch has a first electrode coupled to the clamp capacitor and a second electrode coupled to the second terminal of the control circuit. The control circuit is configured to decrease a voltage difference between the control electrode and the second electrode of the auxiliary switch during a discharging process of the clamp capacitor.

Another embodiment of the present invention discloses an isolated switching converter. The isolated switching converter comprises a transformer having a primary winding and a secondary winding, a primary switch coupled to the primary winding, a secondary switch coupled to the secondary winding, an energy recycle branch and a control circuit. The energy recycle branch has a clamp capacitor, an auxiliary switch and a first resistor connected in series between a first terminal and a second terminal of the primary winding. The auxiliary switch has a first electrode coupled to the clamp capacitor and a second electrode coupled to the first resistor. The control circuit comprises a first terminal, a second terminal and a third terminal. The first terminal of the control circuit is connected to the second terminal of the primary winding and the primary switch. The second terminal of the control circuit is connected to the second electrode of the auxiliary switch to receive a current sense signal representative of a current flowing through the energy recycle branch. The third terminal of the control circuit is connected to a control electrode of the auxiliary switch to control the auxiliary switch. The control circuit is configured to decrease a voltage difference between the control electrode and the second electrode of the auxiliary switch during a discharging process of the clamp capacitor.

Yet another embodiment of the present invention discloses a method of recycling energy for an isolated switching converter. The isolated switching converter has a transformer, a primary switch, a secondary switch and a control circuit. The method comprises the following steps. An energy recycle branch is engaged to be coupled in parallel with a primary winding of the transformer. The energy recycle branch comprises a clamp capacitor, an auxiliary switch and a first resistor connected in series between a first terminal and a second terminal of the primary winding. The auxiliary switch has a first electrode coupled to the clamp capacitor and a second electrode coupled to the first resistor. A first terminal of the control circuit is connected to the second terminal of the primary winding and the primary switch. A second terminal of the control circuit is connected to the second electrode of the auxiliary switch to receive a current sense signal representative of a current flowing through the energy recycle branch. A third terminal of the control circuit is connected to a control electrode of the auxiliary switch for controlling the auxiliary switch. A voltage difference between the control electrode and the second electrode of the auxiliary switch is decreased during a discharging process of the clamp capacitor.

### BRIEF DESCRIPTION OF DRAWINGS

The present invention can be further understood with reference to the following detailed description and the appended drawings, wherein like elements are provided with like reference numerals.

FIG. 1 shows a conventional RCD snubber 10 for an isolated switching converter 100.

FIG. 2 shows an isolated switching converter 200 with active clamp.

FIG. 3 shows an isolated switching converter 300 in accordance with an embodiment of the present invention.

FIG. 4 shows a schematic diagram of a control circuit 20A in accordance with an embodiment of the present invention.

FIG. 5 shows working waveform of the isolated switching converter 200 shown in FIG. 2.

FIG. 6 shows working waveform of the isolated switching converter 300 shown in FIG. 3 in accordance with an embodiment of the present invention.

FIG. 7 shows a schematic diagram of a control circuit 20B for the isolated switching converter 400 in accordance with an embodiment of the present invention.

FIG. 8 shows a schematic diagram of a control circuit 20C for the isolated switching converter 400 in accordance with an embodiment of the present invention.

FIG. 9 shows a schematic diagram of an isolated switching converter 400 in accordance with an embodiment of the present invention.

FIG. 10 shows working principles of an isolated switching converter 400 in accordance with an embodiment of the present invention.

FIG. 11 shows three working waveforms of the isolated switching converter 400 shown in FIG. 10 in accordance with an embodiment of the present invention.

FIG. 12 shows a flow diagram of a method 600 of recycling energy for an isolated switching converter in accordance with an embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration, and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

The present invention can be used in any isolated switching converter. In the following detailed description, for the sake of brevity, only a flyback converter is taken as an example to explain and describe the working principle of the present invention.

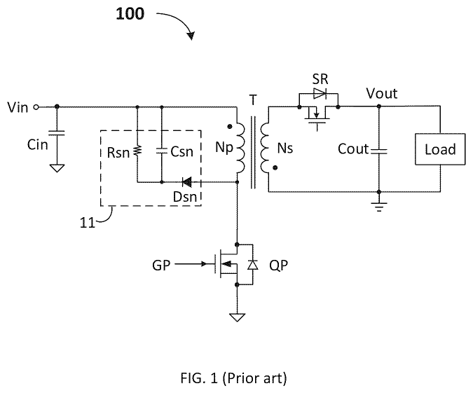

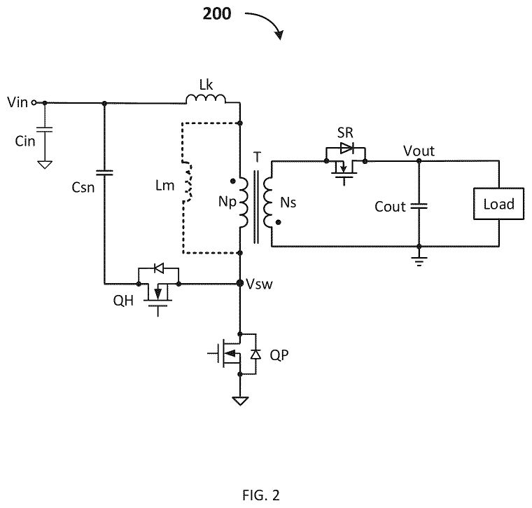

FIG. 2 shows an isolated switching converter 200 with active clamp. As shown in FIG. 2, the isolated switching converter 200 comprises an auxiliary switch QH, a primary switch QP and a secondary switch SR. When the primary switch QP is turned on, the auxiliary switch QH is turned off and remains an off state. A current flows through a primary winding Np of a transformer T and the primary switch QP, to a primary ground, and an energy is then stored in a leakage inductance Lk of the transformer T. Once the primary switch QP is in the off state, the leakage inductance Lk of the transformer T charges a clamp capacitor Csn through a body diode of the auxiliary switch QH, so that the leakage inductance energy is transferred and stored in the clamp capacitor Csn. Then the auxiliary switch QH is turned on. The energy stored in the clamp capacitor Csn is not consumed, but being recycled through the auxiliary switch QH and the transformer T. The auxiliary switch QH provides a bidirectional current path that can help recycle the energy dissipated in the RCD snubber circuit 11 shown in FIG. 1, and fully releases the recycled energy to a secondary side, thereby improving the efficiency of the isolated switching converter 200.

However, the inventor recognized that in some applications, a current oscillation after the auxiliary switch QH is turned off, may cause an early-off problem of the secondary switch SR, which reduce the reliability and efficiency of the isolated switching converter 200. Accordingly, several improvements in at least solving the early-off problem of the secondary switch SR may be desirable.

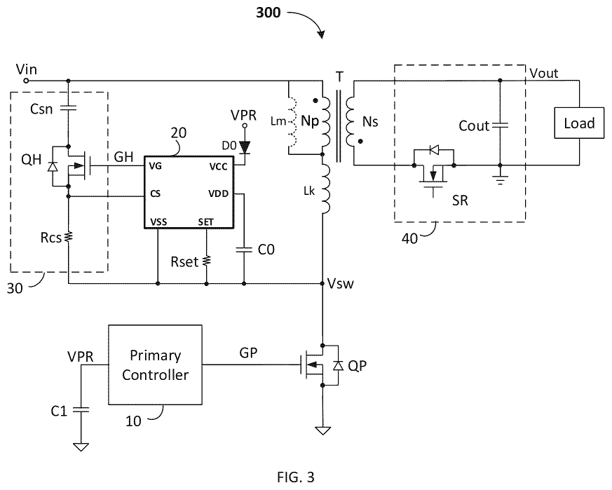

FIG. 3 shows an isolated switching converter 300 in accordance with an embodiment of the present invention. As shown in FIG. 3, the isolated switching converter 300 comprises a transformer T having a primary winding Np and a secondary winding Ns, a primary switch QP, a primary controller 10, a control circuit 20, an energy recycle branch 30 and an output stage circuit 40. The transformer T is coupled to receive an input voltage Vin, and provides an output voltage Vout to a load through a secondary switch SR and an output capacitor Cout of the output stage circuit 40.

The energy recycle branch 30 has a clamp capacitor Csn, the auxiliary switch QH and a current sense resistor Rcs connected in series between a first terminal and a second terminal of the primary winding Np. The primary switch QP is coupled between the second terminal of the primary winding Np and a primary reference ground. The primary switch QP is controlled by a primary driving control signal GP provided by the primary controller 10.

The auxiliary switch QH is coupled in series with a clamp capacitor Csn and the currents sense resistor Rcs to form the energy recycle branch 30. In detail, the auxiliary switch QH has a first electrode coupled to the clamp capacitor Csn and a second electrode coupled to the current sense resistor Rcs.

As shown in FIG. 3, the energy recycle branch 30 is connected in parallel with the primary winding Np. The clamp capacitor Csn has a first terminal coupled to the first terminal of the primary winding Np, a second terminal coupled to the first electrode of the auxiliary switch QH. The second electrode of the auxiliary switch QH is coupled to a first terminal of the current sense resistor Rcs. A second terminal of the current sense resistor Rcs is coupled to the second terminal of the primary winding Np and the primary switch QP.

The control circuit 20 is configured to be an integrated circuit having a plurality of terminals. The plurality of terminals comprises a power supply terminal VCC, a voltage regulating terminal VDD, a ground terminal VSS, a control terminal VG, a current sense terminal CS and a setting terminal SET. The power supply terminal VCC is configured to receive a primary power supply voltage VPR of the primary controller 10 via a diode DO, to provide power for the control circuit 20. And the operation state (ON state or OFF state) of the primary switch can be detected based on a logic state of the primary power supply voltage VPR with respect to a voltage at the ground terminal VSS. In one embodiment, when the primary power supply voltage VPR with respect to the voltage at the ground terminal VSS is logic high, the ON state of the primary switch is detected. In another embodiment, when a duration of the primary power supply voltage VPR being logic high with respect to the voltage at the ground terminal VSS exceeds a predetermined period, the ON state of the primary switch is detected.

The primary power supply voltage VPR received at the power supply terminal VCC is converted to a regulated voltage, which is outputted at the voltage regulating terminal VDD. The voltage regulating terminal VDD is coupled to the ground terminal VSS via a capacitor C0. The ground terminal VSS is coupled to the primary switch QP and the second terminal of the primary winding Np, i.e., a common connection node of the primary winding Np and the primary switch QP. The current sense terminal CS is coupled to the first terminal of the current sense resistor Rcs to receive a current sense signal VCS representative of a current flowing through the energy recycle branch 30. The control terminal VG is coupled to the control electrode of the auxiliary switch QH to control the turning-on and turning-off of the auxiliary switch QH. The setting terminal SET is coupled to an external resistor Rset outside of the control circuit 20, to set a maximum ON-time threshold of the auxiliary switch QH.

As shown in FIG. 3, when the primary switch QP is in the ON state, the auxiliary switch QH is in the OFF state. The current flows through the primary winding Np and the primary switch QP, the energy stores in the transformer T and the leakage inductance Lk. When the primary switch QP is turned off, the stored energy is transferred to the clamp capacitor Csn and the output stage circuit 40 at the secondary side. The current flows from the second terminal of the primary winding Np to charge the clamp capacitor Csn through the current sense resistor Rcs and a body diode of the auxiliary switch QH. Once the current flows through the body diode of the auxiliary switch QH, the auxiliary switch QH will be turned on soon.

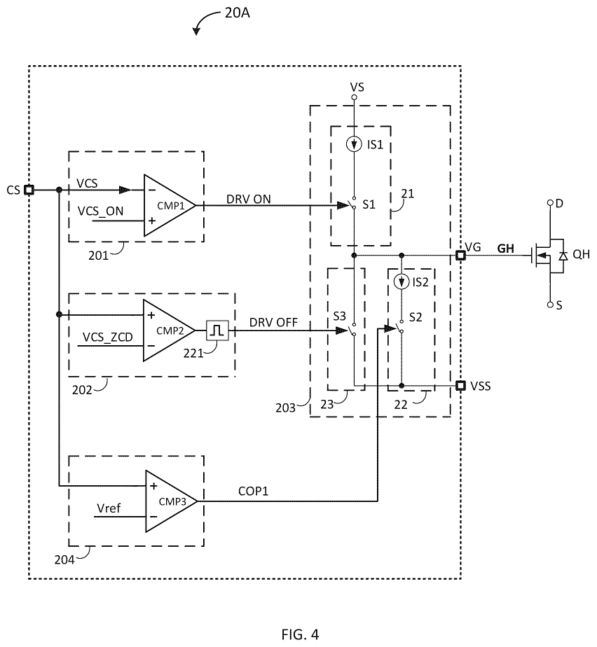

Subsequently, the energy stored in the clamp capacitor Csn is released to the output stage circuit 40 at the secondary side. The clamp capacitor Csn is discharged and the current flows from the auxiliary switch QH to the current sense resistor Rcs and the leakage inductance Lk. According to embodiments of the present invention, a voltage difference between the control electrode of the auxiliary switch QH and the second electrode of the auxiliary switch QH is decreased, to avoid the early-off problem of the secondary switch SR due to the oscillation. Several details of the embodiments are described below with reference to FIGS. 4-6.

FIG. 4 shows a schematic diagram of a control circuit 20A in accordance with an embodiment of the present invention. As shown in FIG. 4, the control circuit 20A comprises an ON control circuit 201, an OFF control circuit 202 and a gate driver 203.

In the embodiment shown in FIG. 4, the control circuit 20A is configured to compare the current sense signal VCS with a turning-on threshold voltage VCS_ON, and to provide an ON control signal DRV_ON. As shown in FIG. 4, the ON control circuit 201 comprises a comparator CMP1. An inverting input terminal of the comparator CMP1 is coupled to the current sense terminal CS to receive the current sense signal VCS representative of the current flowing through the energy recycle branch 30. A non-inverting input terminal of the comparator CMP1 is coupled to receive the turning-on threshold voltage VCS_ON. An output terminal of the comparator CMP1 is configured to provide the ON control signal DRV_ON. In one embodiment, the turning-on threshold voltage is −20 mV. In response to the current sense signal VCS decreasing to the turning-on threshold voltage VCS_ON, the ON control signal DRV_ON changes into a high level from a low level and is activated, and the auxiliary switch QH is turned on.

In the embodiment shown in FIG. 4, the OFF control circuit 202 is configured to compare the current sense signal VCS with a turning-off threshold voltage VCS_ZCD, and to provide an OFF control signal DRV_OFF. As shown in FIG. 4, the OFF control circuit 202 comprises a comparator CMP2 and a falling-edge trigger circuit 221. A non-inverting input terminal of the comparator CMP2 is configured to receive the current sense signal VCS. An inverting input terminal of the comparator CMP2 is coupled to the turning-off threshold voltage VCS_ZCD. An output terminal of the comparator CMP2 is configured to provide the OFF control signal DRV_OFF. In one embodiment, the turning-off threshold voltage VCS_ZCD approaches zero and slightly higher than zero. In response to the current sense signal VCS decreasing to less than the turning-off threshold voltage VCS_ZCD, the OFF control signal DRV_OFF changes into the low level from the high level, the auxiliary switch QH is turned off.

The gate driver 203 has a first input terminal, a second input terminal and an output terminal. The first input terminal of the gate driver 203 is coupled to the ON control circuit 201 to receive the ON control signal DRV_ON, the second input terminal is coupled to the OFF control circuit 202 to receive the OFF control signal DRV_OFF. Baes on the ON control signal DRV_ON and the OFF control signal DRV_OFF, the gate driver 203 provides a driving control signal GH to the control terminal VG of the control circuit 20A.

In one embodiment, the gate driver 203 is configured to have a first driving interval and a second driving interval, respectively. In the first driving interval, a gate voltage VG_QH of the auxiliary switch QH is controlled and kept at a first voltage by the gate driver 203. The gate voltage VG_QH of the auxiliary switch QH is pulled down to reduce the voltage difference (e.g., a gate-source voltage VGS_QH of the auxiliary switch QH) between the control electrode and the second electrode of the auxiliary switch QH in the second driving interval.

In the embodiment shown in FIG. 4, the control circuit 20A further comprises a first comparison circuit 204. The first comparison circuit 204 is configured to determine whether the gate driver 203 enters the second drive interval from the first driving interval. As shown in FIG. 4, the first comparison circuit 204 comprises a comparator CMP3. A non-inverting input terminal of the comparator CMP3 is configured to receive the current sense signal VCS. An inverting input terminal of the comparator CMP3 is coupled to receive a reference threshold voltage Vref. An output terminal of the comparator CMP3 is configured to provide a first comparison signal COP1. In response to the current sense signal VCS increasing to reach the reference threshold voltage Vref, the first comparison signal COP1 changes into the high level from the low level, the second drive interval of the gate driver 203 is activated, the gate driver 203 enters the second drive interval from the first drive interval.

The gate driver 203 further comprises a third input terminal coupled to the output terminal of the first comparison circuit 204 to receive the first comparison signal COP1. In the embodiment shown in FIG. 4, the gate driver 203 comprises a first switchable charge path 21, a first switchable discharge path 22 and a second switchable discharge path 23.

In detail, in response to the ON control signal DRV_ON being activated, i.e., in response to the current sensing signal VCS decreasing to less than the turning-on threshold voltage VCS_ON, the first charge path 21 is closed, for providing the charge path from a power supply voltage VS to the control terminal VG of the control circuit 20A. The gate driver 203 enters the first drive interval, the gate voltage VG_QH of the auxiliary switch QH is pulled up to the first voltage. The gate voltage VG_QH of the auxiliary switch QH is kept at the first voltage during the first drive interval.

In response to the first comparison signal COP1 being activated, i.e., in response to the current sense signal VCS increasing to the reference threshold voltage Vref, the first discharge path 22 is closed for providing a slow discharge path from the control terminal VG to the ground terminal VSS of the control circuit 20A. The gate driver 203 enters the second drive interval from the first drive interval, and the gate voltage VG_QH of the auxiliary switch QH is pulled down gradually.

In response to the OFF control signal DRV_OFF being activated, i.e., in response to the current sense signal VCS decreasing to the turning-off threshold voltage VCS_ZCD, the second discharge path 23 is closed for providing a fast discharge path from the control terminal VG to the ground terminal VSS of the control circuit 20A. The auxiliary switch QH is turned off quickly.

In one embodiment, the first charge path 21 comprises a charging current source IS1 and a first charge transistor S1 connected in series between the power supply voltage VS and the control terminal VG of the control circuit 20A. In other embodiments, the first charge path 21 may comprise a plurality of current source branches to provide a switchable charge path with different driving strength. The first discharge path 22 comprises a discharge current source IS2 and a first discharge transistor S2 connected in series between the control terminal VG and the ground terminal VSS. The second discharge path 23 comprises a second discharge transistor S3 connected between the control terminal VG and the ground terminal VSS. In the example shown in FIG. 4, the second discharge path 23 has a faster discharge speed than that of the first discharge path 22.

In one embodiment, the gate driver 203 controls the turning-on and turning-off of the first charge transistor S1 based on the ON control signal DRV_ON, controls the first discharge transistor S2 based on the first comparison signal COP1, and control the second discharge transistor S3 based on the OFF control signal DRV_OFF. In one embodiment, when the first charge transistor S1 is turned on, the auxiliary switch QH is turned on accordingly. In another embodiment, if the first transistor S2 is turned on, the control electrode of the auxiliary switch QH is electrically connected to the ground terminal VSS through the discharge current source IS2. And the gate voltage of the auxiliary switch QH is pulled down. If the second discharge transistor S3 is turned on, the control electrode of the auxiliary switch QH is directly connected to the ground terminal VSS. And the gate voltage VG_QH of the auxiliary switch QH is pulled down to a zero voltage of the control circuit 20A.

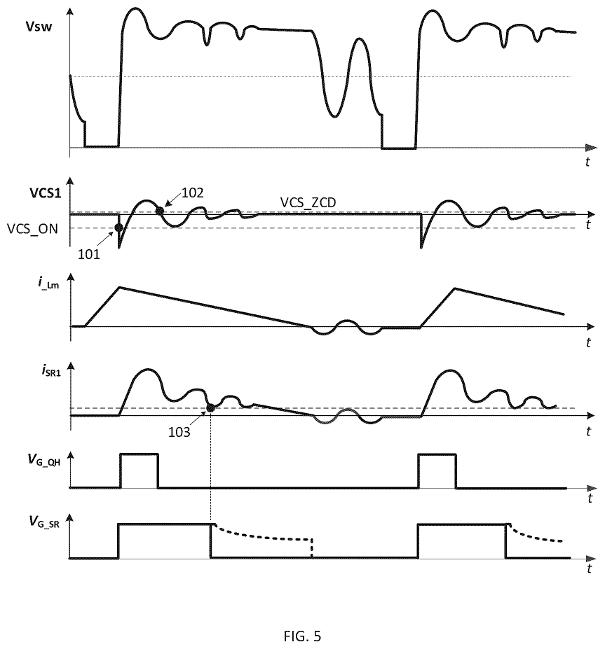

FIG. 5 shows working waveform of the isolated switching converter 200 shown in FIG. 2. As shown in FIG. 5, from the top to the bottom, Vsw refers to a voltage at a common connection node of a primary windings Np and a primary switch QP, VCS1 refers to a current sense signal VCS1 representative of a current flowing through a clamp capacitor Csn, iLm refers to an excitation current flowing through an excitation inductance Lm. iSR1 refers to a current flowing through a secondary switch SR, VG_QH refers to a gate voltage of an auxiliary switch QH, and VG_SR refers to a gate voltage of the secondary switch SR.

It should be noted that, in FIG. 5, the waveform of the voltage Vsw at the common connection node of the primary windings Np and the primary switch QP is plotted using a primary reference ground of the isolated switching converter 200 as a first reference ground potential, while the waveforms of the current sense signal VCS1, the excitation current iLm, and the gate voltage VG_QH of the auxiliary switch QH are plotted using the voltage Vsw as a second reference ground potential. In addition, the secondary current iSR1 and the gate voltage VG_SR of the secondary switch SR are plotted using a secondary reference ground of the isolated switching converter 200 as a third reference ground potential.

There are two sources for the secondary current iSR1 of the secondary switch SR, one is from the excitation inductance Lm of the transformer T, the other is from the clamp capacitor Csn. As shown in FIG. 5, the secondary switch SR is turned on after the primary switch QP is turned off, and the excitation current iLm starts to decrease linearly. In addition, after the primary switch QP is turned off, a current flows from a second terminal of the primary winding Np to the clamp capacitor Csn via the body diode of the auxiliary switch QH, and the auxiliary switch QH is turned on soon, as the point 101 shown in FIG. 5. When the current sense signal VCS1 decreases to a turning-off threshold voltage VCS_ZCD, the auxiliary switch QH is turned off, as the point 102 shown in FIG. 5. The current sense signal VCS1 increases and decreases repeatedly, the clamp capacitor Csn is charged and then is discharged repeatedly, the current sense signal VCS1 may oscillate as shown in FIG. 5. Accordingly, the energy transferred to the secondary side and the secondary current iSR1 may also oscillate. The gate voltage VG_SR of the secondary switch SR is plotted using dotted line in a normal operation. Since the secondary current iSR1 oscillates downward, which causes the secondary current iSR1 to be less than a zero-crossing threshold voltage in advance, the zero-crossing of the secondary current iSR1 is detected in advance. Thus the secondary switch SR is turned off early, as the point 103 shown in FIG. 5. In order to solve the problem mentioned above, several improvements in at least solving the early-off problem of the secondary switch SR are provided.

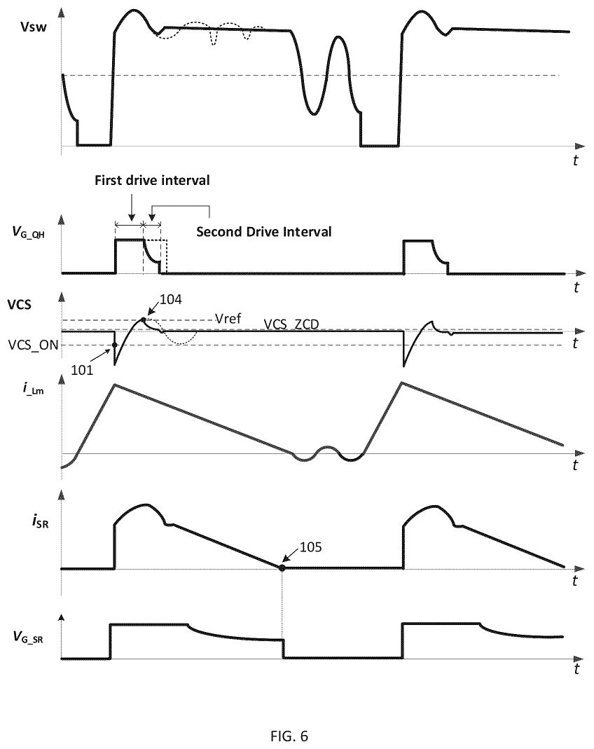

FIG. 6 shows working waveform of the isolated switching converter 300 shown in FIG. 3 in accordance with an embodiment of the present invention. As shown in FIG. 6, from the top to the bottom, Vsw refers to a voltage at a common connection node of the primary windings Np and the primary switch QP, VG_QH refers to the gate voltage of an auxiliary switch QH, VCS refers to the current sense signal VCS representative of the current flowing through the energy recycle branch 30, iLm represents an excitation current flowing through an excitation inductance Lm. iSR refers to a secondary current flowing through the secondary switch SR, and VG_SR refers to a gate voltage of the secondary switch SR.

It should be noted that, in the embodiment shown in FIG. 6, the waveform of the voltage Vsw at the common connection node of the primary windings Np and the primary switch QP is plotted using a primary reference ground of the isolated switching converter 300 as a first reference ground potential, while the waveforms of the current sense signal VCS, the excitation current iLm, and the gate voltage VG_QH of the auxiliary switch QH are plotted using the ground terminal VSS of the control circuit 20 as a second reference ground potential. In addition, the secondary current iSR and the gate voltage VG_SR of the secondary switch SR are plotted using a secondary reference ground of the isolated switching converter 300 as a third reference ground potential.

In the embodiment shown in FIG. 6, after the primary switch QP is turned off, when the current sense signal VCS decreases to the turning-on threshold voltage VCS_ON, the auxiliary switch QH is turned on, as the point 101 shown in FIG. 6. The gate driver 203 enters the first drive interval, the gate voltage VG_QH of the auxiliary switch QH is kept at the first voltage. When the current sense signal VCS increases to the reference threshold voltage Vref, the gate driver 203 enters the second drive interval from the first drive interval, as the point 104 shown in FIG. 6. The gate voltage VG_QH is decreased and thus the gate-source voltage of the auxiliary switch QH is decreased accordingly. The oscillation of the current flowing through the energy recycle branch 30 is suppressed. When the current sense signal VCS decreases to the turning-off threshold voltage VCS_ZCD, the auxiliary switch QH is turned off. After that, the excitation current iLm continues to decrease. Since the oscillation of the current flowing through the energy recycle branch 30 is suppressed, the secondary current iSR does not oscillate any more. The secondary switch SR is turned off until the true zero-crossing of the secondary current iSR, as the point 105 shown in FIG. 6.

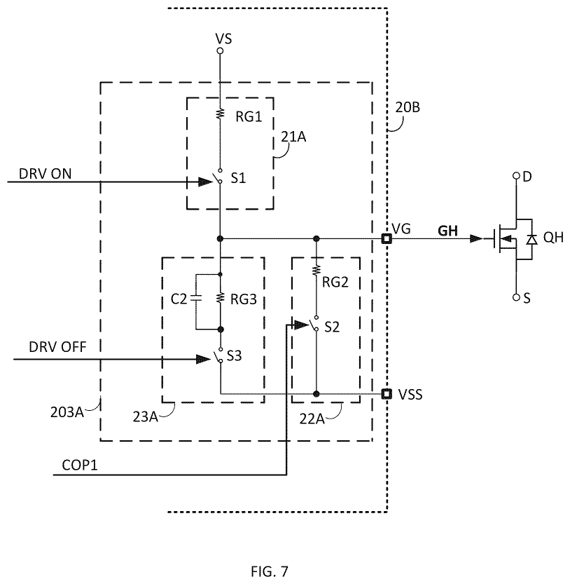

FIG. 7 shows a schematic diagram of a control circuit 20B for the isolated switching converter 400 in accordance with an embodiment of the present invention. As shown in FIG. 7, the gate driver 203A comprises a first input terminal, a second input terminal, a third input terminal, an output terminal, a first charge path 21A from the power supply voltage VS to the control terminal VG, a first discharge path 22A from the control terminal VG to the ground terminal VSS and a second discharge path 23A from the control terminal VG to the ground terminal VGG. The first input terminal of the gate driver 203A is configured to receive the ON control signal DRV_ON. The second input terminal of the gate driver 203A is configured to receive the OFF control signal DRV_OFF. The third input terminal of the gate driver 203A is configured to receive the first comparison signal COP1. An output terminal of the gate driver 203A is configured to provide the driving control signal GH.

In the embodiment shown in FIG. 7, the first charge path 21A comprises a gate resistor RG1 and a first charge transistor S1 connected in series. The first discharge path 22A comprises a gate resistor RG2 and a first discharge transistor S2. The second discharge path 23A comprises a gate resistor RG3 and a second discharge transistor S3. The gate resistors RG1˜RG3 are configured be setting units for gate driving strength, and thus the speed of the turning-on or turning-off of the auxiliary switch QH can be adjusted. For example, the resistance of the gate resistor RG3 is configured to less than that of the gate resistor RG2, and the speed of the turning-off of the auxiliary switch QH with the second discharge path 23A is faster than that of the turning-off of the auxiliary switch QH with the first discharge path 22A. In the embodiment shown in FIG. 7, the second discharge path 23A further comprises a capacitor C1 coupled in parallel with the gate resistor RG3, to accelerate the turning-off of the auxiliary switch QH.

In response to the activated ON control signal DRV_ON, the first charge transistor S1 is turned on, the first charge path 21A is closed, and the auxiliary switch QH is turned on. In response to the activated first comparison signal COP1, the first discharge transistor S2 is turned on, the first discharge path 22A is closed, the gate voltage VG_QH of the auxiliary switch QH is pulled down. In response to the activated OFF control signal DRV_OFF, the second discharge transistor S3 is turned on, the second discharge path 23A is closed, and the auxiliary switch QH is turned off.

In one embodiment, the auxiliary switch QH may be any controllable semiconductor devices, such as a MOSFET (Metal Oxide Semiconductor Field Effect Transistor), a SiC (Silicon Carbide), a GaN (Gallium Nitride) and so on. The auxiliary switch has a first electrode, a second electrode and a control electrode. Based on a driving control signal GH applied to the control electrode of the auxiliary switch QH, the electrical connection between a first electrode of the auxiliary switch QH and the second electrode of the auxiliary switch QH is controlled.

For the sake of brevity, the term “gate” is used herein to refer to the control electrode of the auxiliary switch QH (e.g., a gate of a MOSFET, a gate of a SiC, a gate of a GaN and/or the like). The gate of the auxiliary switch QH may behave as a capacitor. When the gate driver 203 is connected to the gate of the auxiliary switch QH, the gate is charged to allow a current to flow between the first electrode of the auxiliary switch QH and the second electrode of the auxiliary switch QH. The speed at which the gate is charged, i.e., the speed at which the gate current and voltage are made available, may be dependent on a driving strength of the gate driver 203.

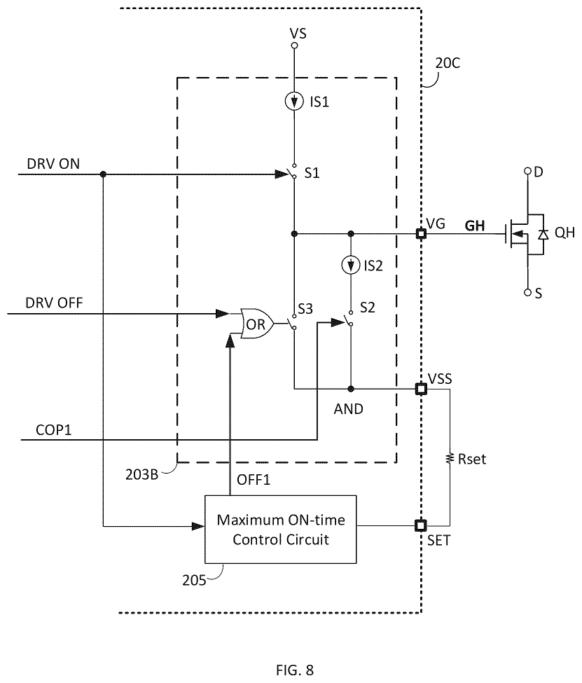

FIG. 8 shows a schematic diagram of a control circuit 20C for the isolated switching converter 400 in accordance with an embodiment of the present invention. Compared with the control circuit 20A shown in FIG. 4, the control circuit 20C shown in FIG. 8 further comprises a maximum ON-time control circuit 205. Compared with the gate driver 203 shown in FIG. 4, the gate driver 203B shown in FIG. 8 further comprises an OR gate circuit OR.

In the embodiment shown in FIG. 8, the maximum ON-time control circuit 205 has a first input terminal, a second input terminal and an output terminal. The first input terminal of the maximum ON-time control circuit 205 is coupled to the control terminal VG or the ON control circuit 201, to receive the driving control signal GH or the ON control signal DRV_ON. The second input terminal of the maximum ON-time control circuit 205 is coupled to the setting terminal SET. The output terminal of the maximum ON-time control circuit 205 is configured to provide a maximum ON-time control signal OFF1. The OR gate circuit OR has a first input terminal to receive the OFF control signal DRV_OFF, a second input terminal to receive the maximum ON-time control signal OFF1, and an output terminal coupled to a control terminal of the second discharge transistor S3. After the auxiliary switch QH is turned on, the maximum ON-time control circuit 205 starts to time. When the timing duration reaches a maximum ON-time threshold, the maximum ON-time control circuit 205 provides the maximum ON-time control signal OFF1 at the output terminal, the second discharge path 23A is closed by the OR gate circuit OR, and the auxiliary switch QH is turned off quickly, to make sure the maximum ON-time of the auxiliary switch QH not greater than the maximum ON-time threshold. In one embodiment, the maximum ON-time threshold may be set through an external resistor Rset coupled to the setting terminal SET of the control circuit 20C.

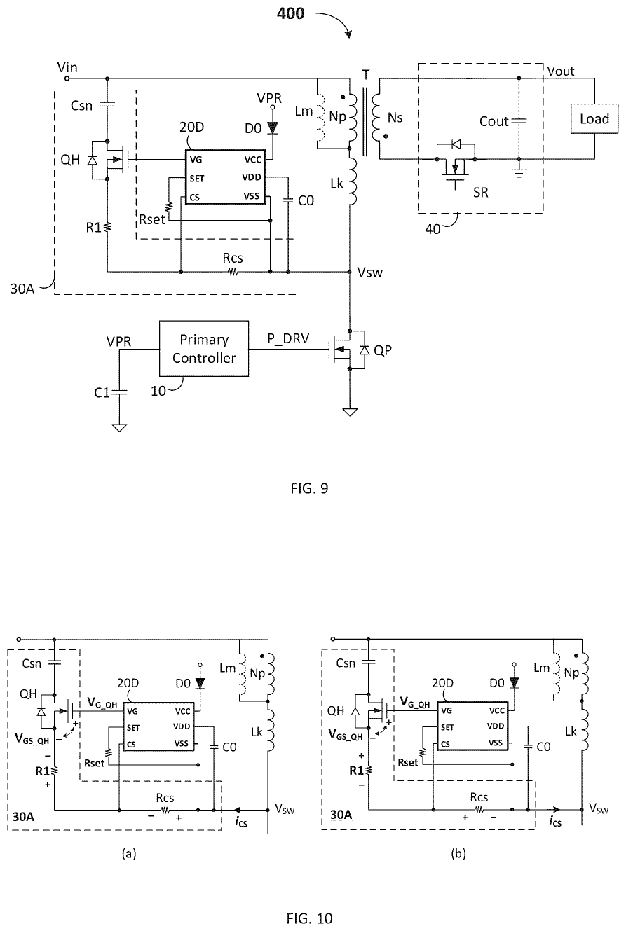

FIG. 9 shows a schematic diagram of an isolated switching converter 400 in accordance with an embodiment of the present invention. Compared with the energy recycle branch 30 shown in FIG. 4, the energy recycle branch 30A shown in FIG. 9 further comprises a resistor R1 coupled in series between the second electrode of the auxiliary switch QH and the first terminal of the current sense resistor Rcs. The details of the embodiments described below with reference to FIG. 10.

FIG. 10 shows working principles of an isolated switching converter 400 in accordance with an embodiment of the present invention. As shown in FIG. 10 (a), when the primary switch QP is turned off, a current ics flows from the second terminal of the primary winding Np through the current sense resistor Rcs, the resistor R1, the body diode of the auxiliary switch QH, to charge the clamp capacitor Csn. Once the current ics flows through the body diode of the auxiliary switch QH, the auxiliary switch QH will be turned on soon. And the gate-source voltage VGS_QH of the auxiliary switch QH may be given by the following equation (1):

$${V}_{GS \_ QH} = {V}_{G \_ QH} + {i}_{cs} ( {R}_{1} + {R}_{cs} ) \qquad ( 1 )$$

Subsequently, as shown in FIG. 10(b), during a discharging process of the clamp capacitor Csn, the current ics starts to reverse and flows from the auxiliary switch QH to the leakage inductance Lk through the resistor R1 and the current sense resistor Rcs. At this moment, the gate-source voltage VGS_QH of the auxiliary switch QH is given by the following equation (2):

$${V}_{GS \_ QH} = {V}_{G \_ QH} - {i}_{cs} ( {R}_{1} + {R}_{cs} ) \qquad ( 2 )$$

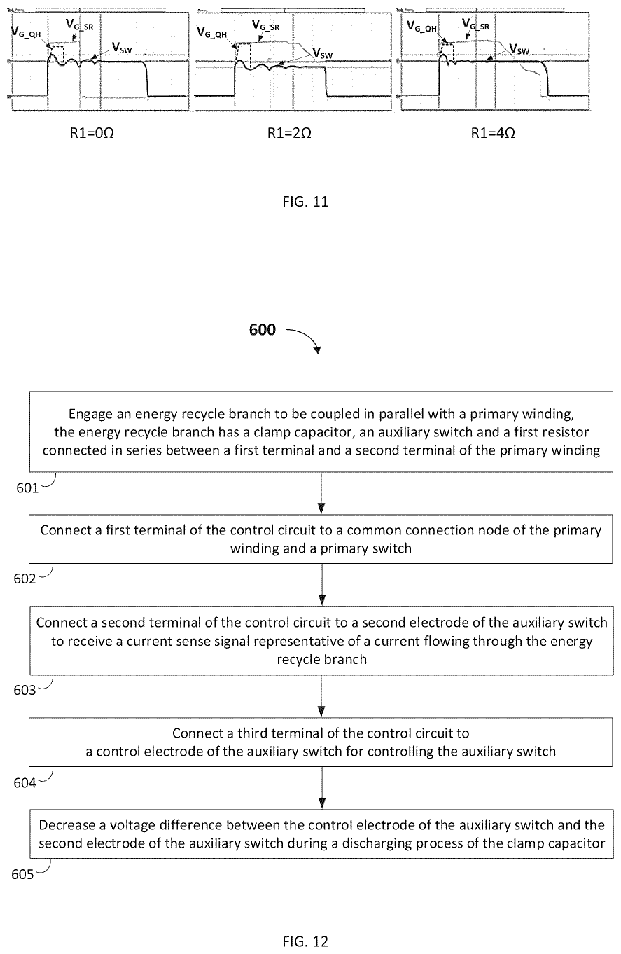

It can be seen from the equations (1) and (2), the gate-source voltage VGS_QH of the auxiliary switch QH is decreased during the discharging process of the clamp capacitor Csn. The oscillation of the voltage Vsw at the common connection node of the primary winding Np and the primary switch QP is decreased accordingly, and the early off of the secondary switch SR can be avoided. Several of the details of the embodiments described below with reference to FIG. 11.

FIG. 11 shows three working waveforms of the isolated switching converter 400 shown in FIG. 10 in accordance with an embodiment of the present invention. From the left to the right, the different working conditions of the isolated switching converter 400 under different resistance of the resistor R1 are shown in FIG. 4, from R1=0Ω, R1=2Ω to R1=4Ω. When R1=0Ω, the oscillation of the voltage Vsw at the common connection node is the most obvious, and the secondary switch SR is turned off early due to the obvious oscillation.

When the resistance is increased, for example, R1=4Ω, the oscillation of the voltage Vsw at the common connection node is suppressed, so as to ensure the normal turning-off of the secondary switch QH.

FIG. 12 shows a flow diagram of a method 600 of recycling energy for an isolated switching converter in accordance with an embodiment of the present invention. The isolated switching converter has a transformer with a primary winding and a second winding, a primary switch and a secondary switch. The method 600 comprises the steps 601˜605.

In step 601, an energy recycle branch is engaged to be coupled in parallel with a primary winding of the transformer. The energy recycle branch has a clamp capacitor, an auxiliary switch and a current sense resistor connected in series between a first terminal and a second terminal of the primary winding. The auxiliary switch has a first electrode coupled to the clamp capacitor and a second electrode coupled to the current sense resistor.

In one embodiment, the energy recycle branch further comprises a resistor connected in series between the second electrode of the auxiliary switch and the current sense resistor.

In step 602, a first terminal of the control circuit is connected to the second terminal of the primary winding and the primary switch.

In step 603, a second terminal of the control circuit is connected to the second electrode of the auxiliary switch to receive a current sense signal representative of a current flowing through the energy recycle branch.

In step 604, a third terminal of the control circuit is connected to a control electrode of the auxiliary switch for controlling the auxiliary switch.

In step 605, a voltage difference between the control electrode and the second electrode of the auxiliary switch is decreased during a discharging process of the clamp capacitor.

In one embodiment, in a first drive interval, the gate voltage of the auxiliary switch is kept in a first voltage. The gate voltage of the auxiliary switch is pulled down when switched to enter a second drive interval from the first drive interval.

In one embodiment, when the current sense signal increases to a reference threshold voltage, the first drive interval is switched to the second drive interval.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated, and they obviously will be resorted to by those skilled in the art without departing from the spirit and the scope of the invention as hereinafter defined by the appended claims as only a preferred embodiment(s) thereof has been disclosed.

What is claimed is:

1. A control circuit for an isolated switching converter having a transformer with a primary winding and a secondary winding, a primary switch, a secondary switch, and an energy recycle branch, wherein the energy branch has a clamp capacitor, an auxiliary switch and a first resistor connected in series between a first terminal and a second terminal of the primary winding, the control circuit comprising:
a first terminal connected to the second terminal of the primary winding and the primary switch;
a second terminal connected to the first resistor receive a current sense signal representative of a current flowing through the energy recycle branch; and
a third terminal connected to a control electrode of the auxiliary switch to control the auxiliary switch, wherein the auxiliary switch has a first electrode coupled to the clamp capacitor and a second electrode coupled to the second terminal of the control circuit; and wherein
the control circuit is configured to decrease a voltage difference between the control electrode and the second electrode of the auxiliary switch during a discharging process of the clamp capacitor.

2. The control circuit of claim 1, further comprises:
an ON control circuit configured to compare the current sense signal with a turning-on threshold voltage and to provide an ON control signal;
an OFF control circuit configured to compare the current sense signal with a turning-off threshold voltage and to provide an OFF control signal; and
a gate driver configured to provide a driving control signal to the third terminal of the control circuit based on the ON control signal and the OFF control signal, wherein in a first drive interval, a gate voltage of the auxiliary switch is controlled and kept in a first voltage by the gate driver, and the gate voltage of the auxiliary switch is pulled down when entering the second drive interval from the first drive interval.

3. The control circuit of claim 2, further comprises:
a first comparison circuit configured to compare the current sense signal with a reference threshold voltage and to provide a first comparison signal to determine if entering the second drive interval from the first drive interval.

4. The control circuit of claim 3, wherein the gate driver comprises:
a first charge path from a power supply voltage to the third terminal of the control circuit, and configured for being closed and open based on the ON control signal;
a first discharge path from the third terminal of the control circuit to the first terminal of the control circuit, configured for being closed and open based on the first comparison signal; and
a second discharge path from the third terminal of the control circuit to the first terminal of the control circuit, configured for being closed and open based on the OFF control signal.

5. The control circuit of claim 4, wherein:
the first discharge path comprises a current source and a first discharge transistor coupled in series between the third terminal and the first terminal of the control circuit; and
the second discharge path comprises a second discharge transistor coupled in series between the third terminal and the first terminal of the control circuit.

6. The control circuit of claim 4, wherein:
the first discharge path comprises a first gate resistor and a first discharge transistor coupled in series between the third terminal and the first terminal of the control circuit; and
the second discharge path comprises a first circuit branch and a second discharge transistor coupled in series between the third terminal and the first terminal of the control circuit, wherein the first circuit branch comprises a capacitor coupled in parallel with a second gate resistor.

7. The control circuit of claim 2, further comprises:
a maximum ON-time control circuit configured to provide a maximum ON-time control signal to turn off the auxiliary switch when an ON-time of the auxiliary switch reaches a maximum ON-time threshold.

8. The control circuit of claim 1, wherein the energy recycle branch further comprises:
a second resistor connected in series between the second electrode of the auxiliary switch and the first resistor.

9. An isolated switching converter, comprising:
a transformer, having a primary winding and a secondary winding;
a primary switch coupled to the primary winding;
a secondary switch coupled to the secondary winding;
an energy recycle branch having a clamp capacitor, an auxiliary switch and a first resistor connected in series between a first terminal and a second terminal of the primary winding, wherein the auxiliary switch has a first electrode coupled to the clamp capacitor and a second electrode coupled to the first resistor; and
a control circuit, comprising:
a first terminal connected to the second terminal of the primary winding and the primary switch;
a second terminal connected to the second electrode of the auxiliary switch to receive a current sense signal representative of a current flowing through the energy recycle branch; and
a third terminal connected to a control electrode of the auxiliary switch to control the auxiliary switch; and wherein
the control circuit is configured to decrease a voltage difference between the control electrode and the second electrode of the auxiliary switch during a discharging process of the clamp capacitor.

10. The isolated switching converter of claim 9, wherein the control circuit comprises:
an ON control circuit configured to compare the current sense signal with a turning-on threshold voltage and to provide an ON control signal;
an OFF control circuit configured to compare the current sense signal with a turning-off threshold voltage and to provide an OFF control signal; and
a gate driver configured to provide a driving control signal to the third terminal of the control circuit based on the ON control signal and the OFF control signal, wherein in a first driving interval, a gate voltage of the auxiliary switch is controlled and kept in a first voltage by the gate driver, and the gate voltage of the auxiliary switch is pulled down when entering the second drive interval from the first drive interval.

11. The isolated switching converter of claim 10, wherein the control circuit further comprises:
a first comparison circuit configured to compare the current sense signal with a reference threshold voltage and to provide a first comparison signal to determine if entering the second drive interval from the first drive interval.

12. The isolated switching converter of claim 11, wherein the gate driver comprises:
a first charge path from a power supply voltage to the third terminal of the control circuit, configured for being closed and open based on the ON control signal;
a first discharge path from the third terminal of the control circuit to the first terminal of the control circuit, configured for being closed and open based on the first comparison signal; and
a second discharge path from the third terminal of the control circuit to the first terminal of the control circuit, configured before being closed and open based on the OFF control signal.

13. The isolated switching converter of claim 9, wherein the energy recycle branch further comprises:
a second resistor connected in series between the second electrode of the auxiliary switch and the first resistor.

14. A method of recycling energy for an isolated switching converter having a transformer, a primary switch, a secondary switch and a control circuit, the method comprising:
engaging an energy recycle branch to be coupled in parallel with a primary winding of the transformer, wherein the energy recycle branch has a clamp capacitor, an auxiliary switch and a first resistor connected in series between a first terminal and a second terminal of the primary winding, the auxiliary switch has a first electrode coupled to the clamp capacitor and a second electrode coupled to the first resistor;
connecting a first terminal of the control circuit to the second terminal of the primary winding and the primary switch;
connecting a second terminal of the control circuit to the second electrode of the auxiliary switch to receive a current sense signal representative of a current flowing through the energy recycle branch;
connecting a third terminal of the control circuit to a control electrode of the auxiliary switch for controlling the auxiliary switch; and
decreasing a voltage difference between the control electrode and the second electrode of the auxiliary switch during a discharging process of the clamp capacitor.

15. The method of claim 14, wherein:
in a first driving interval, a gate voltage of the auxiliary switch is controlled and kept in a first voltage; and
the gate voltage of the auxiliary switch is pulled down when entering a second drive interval from the first drive interval.

16. The method of claim 15, wherein:
entering to the second drive interval from the first drive interval in response to the current sense signal being higher than a reference threshold voltage.

17. The method of claim 14, wherein:
closing a first charge path from a power supply voltage to the third terminal of the control circuit, in response to the current sense signal decreasing to less than a turning-on threshold voltage.

18. The method of claim 14, wherein:
closing a first discharge path from the third terminal of the control circuit to the first terminal of the control circuit, in response to the current sense signal increasing to reach a reference threshold voltage; and
closing a second discharge path from the third terminal of the control circuit to the first terminal of the control circuit, in response to the current sense signal decreasing to less than a turning-off threshold voltage.

19. The method of claim 14, further comprising:
providing a maximum ON-time control signal to turn off the auxiliary switch when an ON-time of the auxiliary switch reaches a maximum ON-time threshold.

20. The method of claim 14, wherein the energy recycle branch further comprises:
a second resistor connected in series between the second electrode of the auxiliary switch and the first resistor.
